(19) United States
(12) Patent Application Publication
(10) Pub. No.: US 2002/0044545 A1
(43) Pub. Date: Apr. 18, 2002

(54) System and apparatus for connecting a telecommunications device to a packet-switching communications network

(76) Inventors: Thomas Brumm, Gauting-Koenigswiesen (DE); Udo Klotz, Neuried (DE); Norbert Loebig, Darmstadt (DE); Walter Zinkl, Wien (DE); Patrick Kleiner, Muenchen (DE); Robert Kresnik, Slovenska Bistrica (SI); Irena Romanski, Egling (DE)

Correspondence Address: Bell, Boyd & Lloyd LLC, P.O. Box 1135, Chicago, IL, 60690, US

(21) Appl. No.: 09/827,487

(22) Filed: Aug. 9, 2001

(30) Foreign Application Priority Data
Apr. 6, 2000 (DE) 10017229.6

(51) Int. Cl. H04J 3/22

(52) U.S. Cl. 370/352; 370/466

(57) ABSTRACT

A system for connecting a telecommunications terminal or a private branch exchange to a packet-switching communications network, and to an interface unit, a communications terminal and a private branch exchange for connection to a packet-switching communications network. The system has at least one telecommunications device, for example a telephone or a private branch exchange, which can be connected to a line-switching communications network. Furthermore, this system contains an interface unit which is connected both to the packet-switching communications network and to the telecommunications device. The interface unit converts at least some of the data intended for the subscriber line using the user-switching communications network into data of a line-switching communications network.

### BACKGROUND OF THE INVENTION

1. Field of the Invention

The present invention relates to both a system and an interface unit for connecting a telecommunications device to a packet-switching communications network, and to a communications terminal and a private branch exchange for connection to a packet-switching communications network. The system contains at least one telecommunications device which can be connected to a line-switching communications network. A packet-switching communications network is used to transmit data between a first and a second subscriber line of the packet-switching communications network.

2. Description of the Prior Art

There are various types of communications networks for transmitting voice, video data and further data. Different services and features have been developed for each of these communications networks by virtue of the various ways in which these communications networks can be used. Conventional communications networks for the transmission of voice are generally line-switching communications networks and communications networks for transmitting other data are usually packet-switching communications networks; for example, a local computer network (Local Area Network; LAN) or the Internet. However, at present, voice, data and video services of both types of communications network can be made available. It is therefore possible, for example, to connect a subscriber to the line-switching communications network via a packet-switching communications network. Supplementary services such as call pick-up, three-way conferencing, large-scale conferencing, holding, displaying of toll information, closed user group, call number identification, automatic call-back when busy, automatic call-back when no response, call barring, indications of call waiting and call transfer which are made available in known line-switching communications networks also can, to a certain extent, be used in packet-switching communications networks. Standards, for example in the series of the Recommendations of the International Telecommunication Union-Telecommunications Standardization Sector (ITU-T Recommendation) based on the H.323 are defined for packet-switching communications networks. These standards include, in particular, the Standards H.323, H.225, H.245 and H.450.

An H.323 architecture for supplementary services in which there is a possibility of interaction of the services between line-switching and packet-switching communications networks is also known. For example, it is known that user-channel-related signaling messages for activating, deactivating, requesting and controlling service features and features in the line-switching communications network are mapped onto signaling packets which are used in the packet-switching communications network. Preferably, so-called DSS1 messages which are defined in the ITU Standards Q.931 and Q.932 are used in the line-switching communications network. Preferably the standardized H.225 signaling protocol is used for transmitting the signaling packets in the packet-switching communications network, in particular in the Internet. Service features and features which to be used require user-channel-related signaling messages are, for example, call pick-up, three-way conferencing and large-scale conferencing, holding, displaying of toll information, closed user group and call number identification services. Signaling which is independent of a user connection or a user channel is necessary for status interrogations and for activating or deactivating service features; for example, call divert, automatic call-back when busy, automatic call-back when no response and when waiting messages are indicated.

Components such as terminals, gateways and gatekeepers are provided and defined for transmitting voice according to the H.323 Standard. Terminals are terminating devices which are connected to the packet-switching communications network. In packet-switching communications networks it is necessary for the subscriber to log on with his terminal. A gateway is used as an interface for converting the data protocols between the packet-switching communications network and line-switching communications network. A gatekeeper is used to administer and to check user services and network capacities of a packet-switching communications network according to the H.323 Standard. The addressing of an incoming call also takes place in the gatekeeper in the packet-switching communications network. Each subscriber has an address in the packet-switching communications network. The telephone number which is dialed by a calling subscriber is converted by the gatekeeper to the address of the subscriber in the packet-switching communications network. In this way, the H.323 Standard can be used to transmit telephone calls on the Internet and in networks based on an Internet protocol.

In general, personal computers with suitable software and hardware are used as terminals for voice connections via a packet-switching communications network. However, this method of telephoning is unusual and inconvenient for most telephone subscribers. This personal computer also must be continuously in operation for the subscriber to be accessible. Furthermore, there are so-called IP telephones which are suitable for direct connection to a communications network based on an Internet protocol. These devices are usually very expensive and frequently do not have the same functional range to which subscribers of conventional analog and ISDN telephones are accustomed. Other telecommunications terminals which are suitable for connection to an IP communications network, for example facsimile devices or telephone answering machines, are not known.

An object of the present invention is, therefore, to provide a system which makes it possible, with a low level of expenditure, to provide a subscriber in a packet-switching communications network with the same communications convenience as on a subscriber line of a line-switching communications network.

### SUMMARY OF THE INVENTION

Accordingly, the system of the present invention can be used to connect known communications terminals, for example analog telephones, ISDN telephones, telephone answering machines, facsimile devices and modems which are provided for connection to the line-switching communications network to a packet-switching communications network. Furthermore, the system of the present invention makes it possible to connect a known private branch exchange to a packet-switching communications network.

Existing communications terminals or private branch exchanges for connection to line-switching communications networks can, thus, continue to be used when connecting to a packet-switching communications network. The expense involved in acquiring analog and ISDN communications terminals is significantly lower than when acquiring a special IP terminal. Personal computers with suitable software and hardware are often used as IP terminals. In order to access the subscriber, such a personal computer must continuously be in operation. The power drain of a personal computer is generally significantly higher than the power drain of a conventional communications terminal, as a result of which the operating costs of a personal computer as IP terminal are also relatively high. According to the system of the present invention, the overall power drain of the communications device and of the interface unit is generally significantly lower than the power drain of an average personal computer. As a result, the operating costs also can be reduced.

In one advantageous embodiment of the present invention, the interface unit converts user data and/or signaling data which are fed to the subscriber terminal using the packet-switching communications network into user or signaling data of the line-switching communications network, and vice versa. This ensures that the communications device can be used to exchange both user data, for example voice data, with a further subscriber line and signaling information can be exchanged between the telecommunications device and the packet-switching communications network, for example for performing connection setups and/or for activating, deactivating and controlling features.

It is advantageous to convert the signaling messages of the line-switching communications network into equivalent signaling messages of the packet-switching communications network, and vice versa. This conversion can be carried out using, for example, equivalent signaling messages stored in a database. Using such a database it is easily possible to convert signaling messages of the packet-switching communications network into signaling messages of the line-switching communications network. Signaling messages to which no equivalent signaling message is assigned can be transmitted as user data using a data packet. This relates, in particular, to signaling messages for controlling, activating and deactivating features of the line-switching communications network which are not supported by the packet-switching communications network. The signaling information contained in the data packets can then be converted into signaling messages of the line-switching communications network at another subscriber line or at an interface of the packet-switching communications network to a line-switching communications network.

In one advantageous embodiment of the present invention, the interface program generates messages which the packet-switching communications network and/or the line-switching communications network requires as acknowledgement of transmitted signaling data. This ensures that each signaling message is correctly terminated even if it is not supported by the respective other communications network; i.e., if the respective other communications network does not generate an acknowledgement which is necessary. The signaling, or the respective signaling protocol, can thus be correctly terminated for the respective communications network.

In another embodiment of the present invention, the signaling messages are used both for connection setup and for connection release between the first and second subscribers and for activating, deactivating and/or registering at least one service feature; for example, call pick-up, three-way conferencing, large-scale conferencing, holding, displaying of toll information, closed user group, call number identification, automatic callback when busy, automatic callback when no response, call barring, indication of call waiting and call transfer. Even a subscriber on a subscriber line of the packet-switching communications network is thus provided with service features and/or features which are generally available to subscribers of line-switching communications networks.

In one development of the present invention, the signaling messages in the packet-switching communications network also can be transmitted independently of connections. This makes it possible to make available service features and/or features such as automatic callback when busy and further service features which do not require a connection for the service feature to be used.

In another embodiment, the signaling messages of the line-switching communications network are DSS1 messages which are defined in the ITU Standards Q.931 and Q.932. This makes it possible for ISDN telephones to be easily connected and ISDN service features and/or ISDN features to be easily supported. The DSS1 signaling protocol also can be used to actuate analog telephone terminals; for example, using a known A/B converter.

It is also advantageous to transmit a signaling message in the packet-switching communications network using the H.225 signaling protocol Standard. This H.225 Standard is widespread in packet-switching communications networks, which ensures that subscribers of the packet-switching communications network can process signaling messages of the H.225 Standard, and that interfaces to other communications networks, for example to line-switching communications networks, can convert such signaling data into signaling data for the other communications network.

In another embodiment of the present invention, the interface unit is arranged in a separate physical unit. This makes it possible to connect various communications terminals, for example an ISDN telephone, an analog telephone, an analog modem, an ISDN modem and/or an analog facsimile device to the separate interface unit, for example using a plug-type connector. A further connection is used to connect the separate interface unit to the packet-switching communications network. The communications terminals and/or private branch exchanges thus can be easily connected to the packet-switching communications network.

In other embodiments, the interface unit is a module of the telecommunications unit. By optionally equipping, for example an ISDN telephone, with such an interface module, or without such an interface module, an ISDN telephone or an IP telephone can be manufactured by installing or not installing this interface module. The production costs for such an IP telephone are then relatively low because the ISDN telephone technology which has already been developed can be used to manufacture such an IP telephone without further changes. The same applies to other telecommunications terminals and private branch exchanges.

In another embodiment of the present invention, a control unit of the interface unit logs on the interface unit to the packet-switching communications network automatically. As a result, a known telecommunications terminal or a known private branch exchange can be easily connected to the packet-switching communications network without specialist knowledge and operated without further installation and configuration expenditure. The connection is made simply by connecting the interface unit or the telecommunications device with an integrated interface unit to the packet-switching communications network. The control unit subsequently logs the subscriber on to the packet-switching communications network. The telecommunications terminal is logged on to the packet-switching communications network and ready to operate within a few minutes. Even after an interruption of the power supply to the interface unit or after the interface unit has been reconnected to the packet-switching communications network, a connection is automatically set up to the packet-switching communications network and the subscriber is logged on to the packet-switching communications network.

It is also advantageous if the packet-switching communications network in the system of the present invention is a network based on an Internet protocol. As a result of the high level of availability and the widespread prevalence of networks based on an Internet protocol, it is particularly advantageous to use the system of the present invention to set up voice connections over such a network and to use for this convenient and cost-effective communications terminals which also can be used in line-switching communications networks. As a result, existing terminals can also continue to be used for communication.

Communications terminals and private branch exchanges which are provided for connection to a line-switching communications network can be connected easily and cost-effectively to a packet-switching communications network using the interface unit of the present invention. Such an interface unit is independent of terminals so that known or existing ISDN telephones, ISDN facsimile devices, ISDN modems, ISDN private branch exchanges can be connected to such an interface unit to which, for example, ISDN terminals can be connected. Analog terminals, such as analog telephones, analog facsimile devices, analog modems and analog telephone systems can be connected to the interface unit for ISDN terminals using an A/B converter. An interface unit having the features of claim 21 is also suitable for connection to packet-switching communications network private branch exchanges which primarily require a multiplex connection. Existing communications terminals and private branch exchanges thus can be connected easily and cost-effectively to a packet-switching communications network. Known voice telephone services are used in the packet-switching communications network in a customary way for the subscriber because customary communications terminals, in particular conventional telephones, can be used.

The communications terminal of the present invention can be easily produced using a known communications terminal which is suitable for connection to the line-switching communications network, and an interface unit. The development costs for the development of such a communications terminal are substantially lower than the development costs for a completely new communications terminal for packet-switching communications networks. When the interface unit is embodied as a module of the communications terminal, it is also possible to produce communications terminals which can be used as communications terminals for line-switching communications networks and as communications terminals for packet-switching communications networks either by installing and deinstalling or activating and deactivating this module.

The private branch exchange of the present invention can be produced easily and cost-effectively, since a known private branch exchange is equipped with an interface unit according to the present invention. It is particularly advantageous for this interface unit to be an assembly in the private branch exchange. Known private branch exchanges for connection to a line-switching communications network can be connected to a packet-switching communications network without any further development effort. If the interface unit is an assembly in the private branch exchange, then the private branch exchange can be selectively connected to a line-switching communications network or to a packet-switching communications network by activation and deactivation of this assembly or by installation and removal of this assembly.

Additional features and advantages of the present invention are described in, and will be apparent from, the Detailed Description of the Preferred Embodiments and the Drawings.

### DESCRIPTION OF THE DRAWINGS

FIG. 1 shows the principle of data transmission between a packet-switching communications network and a communications device which is provided for connection to a line-switching communications network;

FIG. 2 shows software architecture of an interface for connecting to a packet-switching communications network communications terminals which are provided for connection to a line-switching communications network;

FIG. 3 shows a schematic view of the conversion of signaling messages of the packet-switching communications network into signaling messages of the line-switching communications network, and vice versa;

FIG. 4 shows an interface unit for connecting an ISDN terminal to a packet-switching communications network;

FIG. 5 shows an interface unit for connecting an analog telephone to packet-switching communications network; and

FIG. 6 shows an interface unit for connecting a private branch exchange to a packet-switching communications network.

### DETAILED DESCRIPTION OF THE PREFERRED EMBODIMENTS

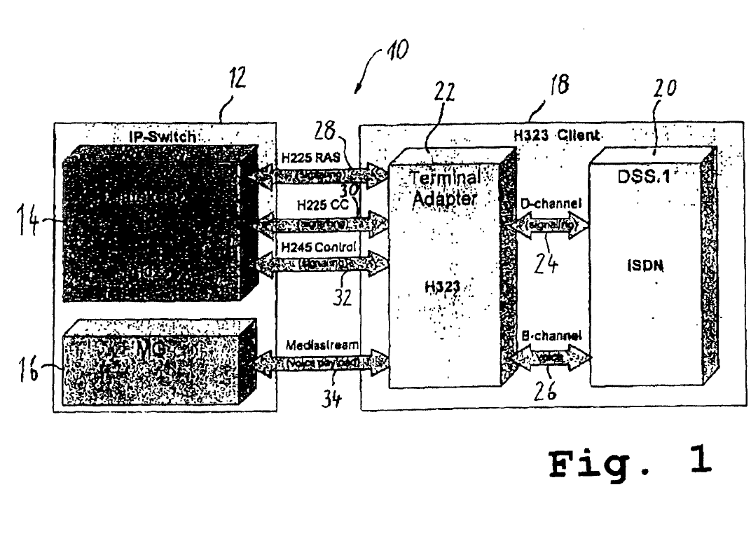

FIG. 1 illustrates a system 10 for connecting a communications terminal 18, which is based on the DSS1-ISDN protocol, to a network which is based on an Internet protocol. The network which is based on the Internet protocol, known for short as IP network, is a packet-switching communications network or data network such as the Internet. A network node 12, which is embodied as an IP switch, is part of the IP network. The network node 12 has a gatekeeper 14 and a media gateway 16 in accordance with the H.323 Standard. Subscribers of the IP network can be connected to this IP network using the gatekeeper and the media gateway. These subscribers are also referred to as H.323 subscribers 18 or as H.323 clients. The H.323 subscriber 18 contains an interface unit 22 and a known ISDN terminal 20. The connection between the interface unit 22, which is also referred to as a terminal adapter, is composed of a so-called D channel 24 for transmitting signaling information, and of at least one so-called B channel 26 for transmitting user data, for example voice data. Furthermore, signaling data are transmitted between the interface unit 22 and the gatekeeper 14 using H.225 registration, administration and status signaling information 28. H.225 signaling information 30 for connection control and H.245 control and signaling data 32 are also exchanged between the interface unit 22 and the gatekeeper 14.

The user data 34 are transmitted as the user data stream, the so-called media stream, between the media gateway 16 and the interface 22. The signaling data 28, 30, 32 include, in particular, signaling information for further service features or features, in particular for voice connections which are defined in the Standard H.245, for example. Further signaling data are transmitted by a line-switching communications network connected to the packet-switching communications network, in the form of data which are not standardized in accordance with a signaling data standard. The data can be exchanged here between, for example, two terminals, such as between the terminal 20 and a further terminal, by exchanging such data directly between the terminals, which is referred to as a data transmission in accordance with the tunnel principle. However, there is also the possibility of signaling data of the line-switching communications network being converted, at an interface between a line-switching communication network and the IP network, into agreed signaling data which are converted into DSS1 signaling information by the interface unit 22. As a result, the subscriber which sets up a connection to a subscriber of a line-switching communications network using the communications terminal 20 is provided with the full range of services and functions of the line-switching communications network and can, thus, make use of all the known service features and features. The user data 34 received from the media gateway 16 are transmitted to the terminal 20 by the interface unit 22 using the B channel protocol 26. The method of operation of the H.323 gatekeeper 14, of the media gateway 16, of the H.323, H.450, H.225, H.245 and of the DSS1 protocol have already been explained in the introduction to the description. Reference is also made to the appropriate Standards of the ITU and its ITU-T Committee.

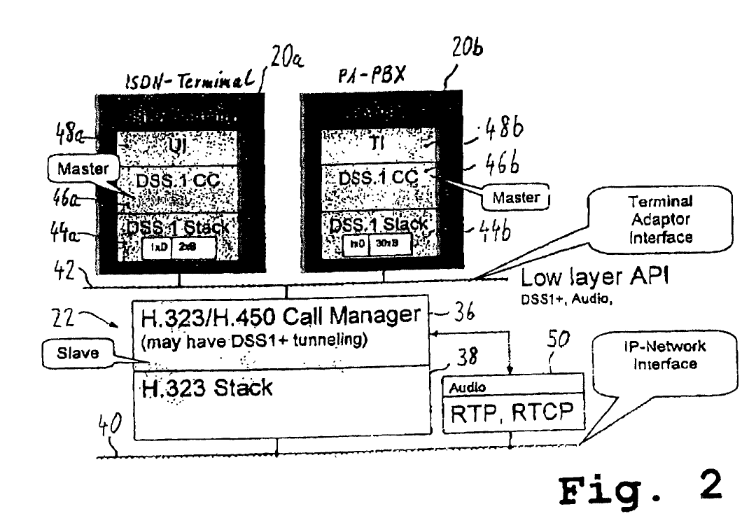

FIG. 2 illustrates software architecture of the interface unit 22 and of an ISDN terminal 20a and of an ISDN private branch exchange 20b. Identical elements have identical reference symbols. The interface unit 22 has a H.323 protocol stack 38, which is also referred to as H.323 stack, and a H.323/H.450 connection controller 36. Signaling data are fed to the H.323 protocol stack using an interface 40 to the IP network. The connection controller 36 also receives user data 50 which are transmitted using a real-time protocol (RTP) and a real-time control protocol (RTCP). Further signaling information, for example signaling information of the DSS1 signaling protocol, also can be transmitted using data packets in accordance with the tunnel principle in which signaling information is transmitted from apparatus to apparatus (end-to-end) in the form of user data. The connection controller 36 terminates the protocols with which the signaling data and the user data have been transmitted by the IP network, and converts the received data into signaling and user data in accordance with the DSS1 protocol. In this way, the interface unit 22 behaves as an H.323 terminal with respect to the IP network.

Both the ISDN terminal 20a and the private branch exchange 20b can be connected to the interface unit 22. The connection controller 36 transfers the signaling data to the DSS1 register 40a, 40b of the DSS1 terminal 20a, 20b using the D channel 24, and transfers the user data to said DSS1 register 40a, 40b using at least one B channel. Customary ISDN terminals 20a, such as an ISDN telephone, are connected to the connection controller 36 via two B channels and a D channel, via a SO interface for example. The ISDN private branch exchange 20b is also connected to the connection controller 36 via a D channel and a number of B channels. These maybe, for example, 30 B channels. The connection controller 36 provides the terminals 20a, 20b with an application program interface using the signaling channels and user channels. The ISDN terminal 20a has a DSS1 register 44a, a DSS1 connection controller 46a and a user plane 48a. The ISDN private branch exchange 20b has a DSS1 register 44b, a DSS1 connection controller 46b and a user plane 48b. The connection controllers 46a, 46b of the communications apparatuses 20a, 20b are used to set up connections and have the function of a master with respect to the connection controller 36 of the interface unit 22. The connection control unit 36 of the interface unit 22 thus has the function of a slave with respect to the communications apparatuses 20a, 20b.

The user level 48a, 48b is principally used to condition the signaling and user data, in particular to actuate input units and output units of the communications apparatuses 20a, 20b. The user level 48b of the private branch exchange 20b is also used to control functions which are possible between telecommunications terminals which are connected to this private branch exchange 20b. The interface unit 22 can be operated in two modes of operation. In the first mode of operation, only the signaling messages present in the H.323/H.245 signaling protocol are converted into equivalent signaling messages of the DSS1 protocol, and vice versa. In the second mode of operation, not only the H.323/H.245 signaling messages but also the DSS1 signaling messages transmitted according to the tunnel principle are processed and transmitted to the respective communications apparatus 20a, 20b as DSS1 signaling messages. The signaling information which is transmitted using the IP network is transmitted in the form of data to the H.323 protocol stack by an IP network connection module, for example from an Ethernet interface card (not illustrated). This IP network connection module also transmits the user data to the connection controller 36.

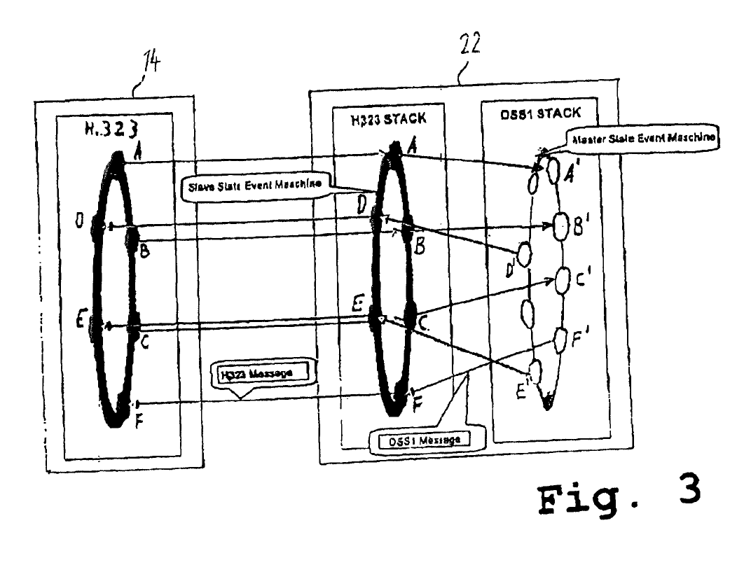

FIG. 3 shows the master-slave principle of the interface unit 22. This principle is clarified using state event machines. An item of signaling information A which has been transmitted via the IP network to the gatekeeper 14 for the subscriber line is transmitted to the H.323 register of the interface unit 22. The signaling information A is an item of signaling information in accordance with the H.323 Standard. The interface unit 22 converts the signaling information A into an equivalent item of signaling information A′ in the DSS1 Standard and transmits it to the DSS1 register of the interface unit 22. The signaling message A′ is transmitted from the DSS1 register of the interface unit 22 to a DSS1 register 44a, 44b of the communications apparatus 20a, 20b. The same procedure is adopted with the signaling messages B and C which are transmitted to the subscriber line using the IP network.

Signaling messages which are to be transmitted from the communications apparatus 20a, 20b to the IP network are fed to the DSS1 register of the interface unit 22. Such a message is, for example, the signaling message D′. The interface unit 22 converts the DSS1 signaling message D′ into an H.323 signaling message D and transmits it to the H.323 register of the interface unit 22. The signaling message D is transmitted from the H.323 register of the interface unit 22 to the H.323 register of the gatekeeper 14. The same procedure is adopted with the DSS1 signaling messages E′ and F′ which are converted into H.323 signaling messages E and F by the interface unit 22. The H.323 register of the interface unit 22 terminates the data transmission protocol between the gatekeeper 14 and the interface unit 22 and acts as a H.323 terminal with respect to the gatekeeper 14. The DSS1 register of the interface unit 22 terminates the DSS1 protocol to the communications terminal 20a, 20b and behaves with respect to this ISDN terminal 20a, 20b as a line-switching communications network which is based on a DSS1 protocol. Furthermore, the interface 22 generates an acknowledgement for H.323 signaling messages which require such an acknowledgement of the H.323 terminal.

Likewise, the interface unit 22 generates an acknowledgement for signaling information of the ISDN terminal 20a, 20b which requires such an acknowledgement of the DSS1 communications network. The assignment, i.e. the conversion, of H.323 signaling information to DSS1 signaling information can be carried out in the interface unit 22 using, for example, a database containing an assignment of equivalent H.323 signaling messages and DSS1 signaling messages. Further signaling messages can be fed to the interface unit by the gatekeeper 14 in the form of data packets containing further DSS1 signaling information which is not supported by the H.323/H.245 Standard. In this way, signaling information which controls service features and features which are not supported by the H.323/H.245 Standard also can be fed to the ISDN communications apparatus 20a, 20b.

The conversion of the H.323 signaling information into DSS1 signaling information, and vice versa, can be carried out, as already mentioned, using a database which is used as a transaction register. The conversion of the signaling information is thus carried out on a logic level. If, for example, the signaling message F′ of the DSS1 register cannot be assigned any equivalent signaling message F of the H.323 register, this DSS1 signaling message is transmitted using a data area of a H.323 signaling packet which is provided for that purpose and which contains the DSS1 signaling message F′. This signaling message F′ is transmitted to an interface between the IP network and a line-switching communications network. This interface may be a gateway, for example. The line-switching communications network also uses DSS1 signaling messages for signaling. At the interface between the IP network and this line-switching communications network, the DSS1 signaling message F′ contained in the H.323 signaling message F is fed to the line-switching communications network. Likewise, DSS1 signaling messages can be transmitted from the line-switching communications network to the communications apparatus 20a, 20b using H.323 signaling messages. This transmission principle also can be used to transmit DSS1 signaling messages, which cannot be converted into H.323 signaling messages, from a line-switching communications network to the interface unit 22, the interface unit 22 feeding these DSS1 signaling messages to the communications apparatus 20a, 20b.

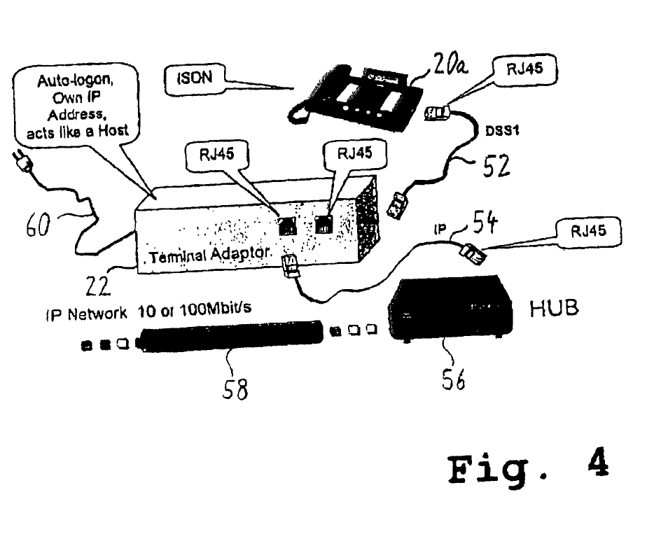

FIG. 4 illustrates an interface unit 22 which connects an ISDN telephone 20a to an IP network 58. The interface unit 22 is connected to a network distributor 56, which is also referred to as a HUB, using a connecting cable 54. The network distributor 56 is connected to the IP network 58. The interface unit 22 is connected to a power supply, for example the public grid, using a power supply cable 60. The ISDN telephone 20a is connected to the interface unit 22 using a connecting cable 52. The connection between the ISDN telephone 20a and interface unit 22 is made using, for example, the standardized SO interface which is used for connecting ISDN telephones with DSS1 signaling protocol.

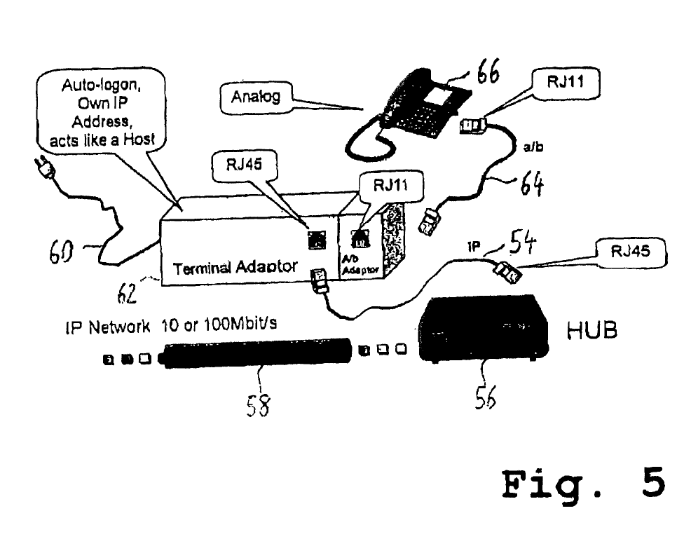

FIG. 5 illustrates a further interface unit 62 for connecting an analog telephone to an IP network 58. The interface unit 62 is of similar design to the interface unit 22 and has a connection 54 to a network distributor 56 which is connected to the IP network 58. Furthermore, the interface unit 62 has a connecting cable 60 to a power supply (not illustrated). In contrast to the interface unit 22, the interface unit 62 has an A/B interface which is used to feed the DSS1 signaling information to analog terminals. The connection between the analog telephone 66 and the interface unit 62 is made using a connecting cable 64.

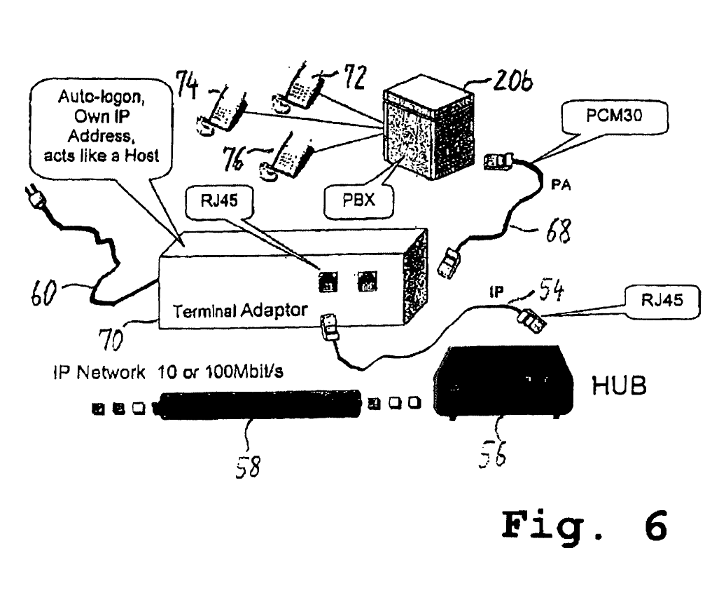

FIG. 6 illustrates an interface unit 70 which is of similar design to the interface units 22 and 62 and is also connected, as are these interface units 22, 62, to a network distributor 56 via a connecting cable 54. The interface unit 70 has access to the IP network 58 using the network distributor 56. The interface unit 70 is used to connect a private branch exchange 20b to which a number of communications terminals, for example the telephones 72, 74, 76, are connected. The connection between the interface unit 70 and private branch exchange 20b is made using a PCM30 link. By using such a PCM link it is possible to transmit data using, for example, 30 user data channels and a signaling channel which each have, for example, a data transmission capacity of 64 kbit/s.

When there is an existing network connection to the IP network 58, the interface units 22, 62, 70 are logged on automatically to the IP network with a preset subscriber address, the so-called IP address, when the power supply of the interface unit 22, 62, 70 is activated. The automatic logging on avoids further installation expenditure when there is a preset IP address. The connections to the power supply, to the IP network via the network distributor 56 and to the private branch exchange 20b, to the ISDN telephone 20a and to the analog telephone 66 also can be set up by persons who are not telecommunications specialists. Existing ISDN and/or analog terminals can be used with the same range of functions as when there is a direct connection to line-switching communications networks. In this way, the operating convenience is maintained completely even when voice connections over an IP network are used. Subscribers can set up voice and data connections to any desired subscribers in IP networks or in line-switching communications networks using the communications terminals 20a, 66, 72, 74, 76.

It is also possible to continue using the known service features and features such as known ISDN features. This relates in particular to service features such as call pick-up, three-way conferencing, large-scale conferencing, holding, displaying of toll information, closed user group, call number identification, automatic callback when busy, automatic callback when no response, call barring, call waiting and call transfer. However, the interface units 22, 62, 70 transmit not only the signaling messages which are transmitted using the IP network 58, but also user data, for example voice data, which are transmitted using the IP network. However, the interface units 22, 62, 70 also can be embodied as a module of the ISDN telephone 20a, of the analog telephone 66 or of the private branch exchange 20b.

An interface unit 22, 62, 70 also can be used to convert signaling messages on the same principle into signaling messages using the DSS1 protocol or based on some other signaling protocol, based on other network protocols such as the SIP protocol. To do this, all that is necessary is to adapt the database of the interface unit 22, 62, 70 and the control of the network protocol. However, when other protocols are converted, it may be found that it is not possible to convert all the features which are known in ISDN. With the H.323 signaling protocol, as with other signaling protocols, the interface unit functions as an IP terminal with respect to the IP network 58 and is, therefore, also referred to as a virtual terminal.

Although the present invention has been described with reference to specific embodiments, those of skill in the art will recognize that changes may be made thereto without departing from the spirit and scope of the invention as set forth in the hereafter appended claims.

We claim as our invention:

1. A system for connecting a telecommunications device to a packet-switching communications network, the system comprising:
at least one telecommunications device which can be connected to a line-switching communications network;
a packet-switching communications network which can be used to transmit first data between a first subscriber line and a second subscriber line of the packet-switching communications network; an interface unit connected to both to the packet-switching communications network and to the telecommunications device, the interface unit converting at least some of the first data, which is intended for the subscriber line using the packet-switching communications network, into second data of the line-switching communications network, and feeding the second data to the telecommunications device, and vice versa.

2. A system for connecting a telecommunications device to a packet-switching communications network as claimed in claim 1, wherein the first and second data are user data.

3. A system for connecting a telecommunications device to a packet-switching communications network as claimed in claim 1, wherein the first and second data are signaling data which contain signaling messages.

4. A system for connecting a telecommunications device to a packet-switching communications network as claimed in claim 3, wherein the interface unit, via an interface program, converts the signaling messages of the packet-switching communications network into equivalent signaling message of the line-switching communications network.

5. A system for connecting a telecommunications device to a packet-switching communications network as claimed in claim 4, wherein the conversion is carried out using equivalent signaling messages stored in a database.

6. A system for connecting a telecommunications device to a packet-switching communications network as claimed in claim 4, wherein the interface program for signaling messages to which no equivalent signaling message is assigned is transmitted using a data packet as user data.

7. A system for connecting a telecommunications device to a packet-switching communications network as claimed in claim 4, wherein the interface program generates messages which at least one of the packet-switching communications network and the line-switching communications network requires as an acknowledgement of transmitted signaling data.

8. A system for connecting a telecommunications device to a packet-switching communications network as claimed in claim 3, wherein the signaling messages are used to make connection setups between the first and second subscribers.

9. A system for connecting a telecommunications device to a packet-switching communications network as claimed in claims 3 wherein the signaling messages are used for at least one of activating, deactivating, and registering at least one service feature.

10. A system for connecting a telecommunications device to a packet-switching communications network as claimed in claim 9, wherein the service feature comprises at least one of call pick-up, three-way conferencing, large-scale conferencing, holding, displaying of toll information, a closed user group, call number identification, automatic callback when busy, automatic callback when no response, call barring, an indication of call waiting and call transfer.

11. A system for connecting a telecommunications device to a packet-switching communications network as claimed in claim 3, wherein the signaling messages are transmitted in the packet-switching communications network independently of user connections.

12. A system for connecting a telecommunications device to a packet-switching communications network as claimed in claim 3, wherein the signaling message of the line-switching communications network are DSS1 messages which are defined in the ITU Standards Q.931 and Q.932.

13. A system for connecting a telecommunications device to a packet-switching communications network as claimed in claim 3, wherein the signaling messages of the packet-switching communications network are signaling messages of the H.225 signaling protocol Standard.

14. A system for connecting a telecommunications device to a packet-switching communications network as claimed in claim 1, wherein the telecommunications device is at least one of an ISDN telephone, an analog telephone, an analog modem, an ISDN modem and an analog facsimile device.

15. A system for connecting a telecommunications device to a packet-switching communications network as claimed in claim 1, wherein the telecommunications device is a private branch exchange.

16. A system for connecting a telecommunications device to a packet-switching communications network as claimed in claim 1, wherein the interface unit is arranged in a separate physical unit.

17. A system for connecting a telecommunications device to a packet-switching communications network as claimed in claim 1, wherein the interface unit is a module in the telecommunications unit.

18. A system for connecting a telecommunications device to a packet-switching communications network as claimed in claim 1, wherein a control unit of the interface unit automatically logs on the interface unit as a subscriber to the packet-switching communications network.

19. A system for connecting a telecommunications device to a packet-switching communications network as claimed in claim 1, wherein the interface unit has a control unit which converts the data using at least one program module.

20. A system for connecting a telecommunications device to a packet-switching communications network as claimed in claim 1, wherein the packet-switching communications network is a network based on an Internet protocol.

21. An interface unit which is connected both to a packet-switching communications network and to a telecommunications device which is provided for connection to a line-switching telecommunications network, comprising a control unit which converts at least one item of signaling information of the packet-switching communications network into an item of signaling information of a line-switching communications network and feeds it to the telecommunications device, and vice versa.

22. An interface unit as claimed in claim 21, wherein the interface unit is used to connect a communications terminal to the packet-switching communications network.

23. An interface unit as claimed in claim 21, wherein the interface unit is used to connect a private branch exchange to the packet-switching communications network.

24. A communications terminal which can be connected to a line-switching communications network and which is used for telecommunications, comprising an interface unit which is connected both to a packet-switching communications network and to a telecommunications device which is provided for connection to a line-switching telecommunication network, the interface unit including a control unit which converts at least one item of signaling information of the packet-switching communications network into an item of signaling information of a line-switching communications network and feeds it to the telecommunications device, and vice versa.

25. A communications terminal as claimed in claim 24, wherein the interface unit is a module of the communications terminal.

26. A private branch exchange which can be connected to a line-switching communications network and which is used for telecommunications, comprising an interface unit which is connected both to a packet-switching communications network and to a telecommunications device which is provided for connection to a line-switching telecommunications network, the interface unit including a control unit which converts at least one item of signaling information of the packet-switching communications network into an item of signaling information of a line-switching communications network and feeds it to the telecommunications device, and vice versa, wherein the interface unit is used to connect the private branch exchange to the packet-switching communications network.

27. A private branch exchange as claimed in claim 26, wherein the interface unit is a module of the private branch exchange.
